(19) United States
(12) Patent Application Publication
(10) Pub. No.: US 2023/0103574 A1
(43) Pub. Date: Apr. 6, 2023

(54) SECURE DEVICE ASSOCIATION USING AUDIO TRANSMISSIONS

(71) Applicant: LISNR, Inc, Cincinnati, OH (US)

(72) Inventors: Jason Nguyen, San Francsico, CA (US); Oz Mendel, Piedmont, CA (US)

(21) Appl. No.: 17/937,895

(22) Filed: Oct. 4, 2022

Related U.S. Application Data
(60) Provisional application No. 63/252,274, filed on Oct. 5, 2021.

(51) Int. Cl. H04L 9/40; G06F 21/32; G06F 21/40

(52) U.S. Cl. CPC H04L 63/083; H04L 63/0861; G06F 21/32; G06F 21/40

(57) ABSTRACT

Methods and systems for securely associated devices using audio transmissions are provided. In one embodiment, a method is provided that includes receiving an audio transmission at a first computing device (e.g., within an audio environment). The audio transmission may be received from a second computing device and may contain a request identifier and a device identifier for the second computing device. The request identifier and device identifier may be transmitted to a third computing device (e.g., via a network). A request for a PIN may be received from the third computing device, and the first computing device may transmit an audio transmission containing the request. The PIN may be received at the first computing device via a further audio transmission from the second computing device and may be provided to the third computing device to approve the request. An approval may be transmitted in another audio transmission.

### CROSS-REFERENCE TO RELATED APPLICATIONS

The present application claims priority to U.S. Provisional Patent Application No. 63/252,274, filed on Oct. 5, 2021, the disclosure of which is incorporated herein by reference for all purposes.

### BACKGROUND

Various software applications enable users to match with other individuals who provide services. For example, the software applications may execute on mobile phones to identify and match users with the individuals providing particular services. To receive these services, it may often be necessary for a user to identify the individual in the real world (e.g., when the individual is near the user).

### SUMMARY

The present disclosure presents new and innovative systems and methods for securely associating devices associated with requests for services. In a first aspect, the techniques described herein relate to a method including: receiving, at a first computing device, a first audio transmission from a second computing device, the first audio transmission containing a request identifier for a request and a first device identifier uniquely identifying the second computing device; transmitting a second audio transmission containing a request for a PIN associated with a user of the second device; receiving a third audio transmission containing the PIN; confirming the PIN is correct; and transmitting a fourth audio transmission containing an approval for the request.

In a second according to the first aspect, the techniques described herein relate to a method, wherein confirming the PIN is correct includes comparing the PIN to an expected PIN received from a third computing device prior to receiving the first audio transmission.

In a third aspect according to at least one of the first and second aspects, the techniques described herein relate to a method, further including, prior to transmitting the second audio transmission: transmitting the request identifier and the first device identifier to a third computing device; and receiving a request for the PIN from the third computing device.

In a fourth aspect according to the third aspect, the techniques described herein relate to a method, wherein confirming the PIN is correct includes: transmitting the PIN to the third computing device; and receiving the approval for the request from the third computing device.

In a fifth aspect according to at least one of the third and fourth aspects, the techniques described herein relate to a method, wherein the request identifier and the first device identifier are received in a payload of the first audio transmission, and wherein the payload is defined by a merchant associated with the third computing device.

In a sixth aspect according to at least one of the third through fifth aspects, the techniques described herein relate to a method, wherein the third computing device is a computing device associated with an online commerce platform.

In a seventh aspect according to at least one of the third through sixth aspects, the techniques described herein relate to a method, wherein the third computing device and the first computing device are located in the same facility.

In an eighth aspect according to at least one of the third through seventh aspects, the techniques described herein relate to a method, wherein, in response to receiving the fourth audio transmission, the second computing device and the third computing device connect and communicate using a network.

In a ninth aspect according to at least one of the first through eighth aspects, the techniques described herein relate to a method, wherein the first device identifier is generated based on a unique identifier of the second computing device.

In a tenth aspect according to the ninth aspect, the techniques described herein relate to a method, wherein the first device identifier is generated based on at least one of a location of the second computing device when the request was created, a MAC address of the second computing device, a universally unique identifier (UUID) associated with the second computing device, a clock time of the second computing device when the request was created, a pressure sensor value of the second computing device when the request was created, an ambient noise level of the second computing device when the request was created, and/or a unique value received by the second computing device upon logging into an account associated with the user.

In an eleventh aspect according to any one of the first through tenth aspects, the techniques described herein relate to a method, wherein the first device identifier is generated based on a biometric scan of the user.

In a twelfth aspect according to at least one of the first through eleventh aspects, the techniques described herein relate to a method, wherein the PIN includes at least one of (i) a unique alphanumeric identifier and (ii) a unique identifier generated based on a biometric scan of the user.

In a thirteenth aspect, the techniques described herein relate to a system including a processor and memory storing instructions which, when executed by the processor, cause the processor to: receive, at a first computing device, a first audio transmission from a second computing device, the first audio transmission containing a request identifier for a request and a first device identifier uniquely identifying the second computing device; transmit a second audio transmission containing a request for a PIN associated with a user of the second device; receive a third audio transmission containing the PIN; confirm the PIN is correct; and transmit a fourth audio transmission containing an approval for the request.

In a fourteenth aspect, the techniques described herein relate to a method including: receiving, at a first computing device, a first audio transmission containing a beacon signal, wherein the first audio transmission was transmitted by a second computing device; transmitting, from the first computing device, a second audio transmission containing a request identifier for a request and a first device identifier uniquely identifying the first computing device; transmitting, from the second computing device, the request identifier and the first device identifier to a third computing device; comparing, at the third computing device, the first device identifier to a second device identifier stored in association with the request identifier; determining, at the third computing device, that the first device identifier and the second device identifier correspond to the request identifier; transmitting, from the second computing device, a third audio transmission containing request for a PIN associated with a user of the first computing device; transmitting, from the first computing device, a fourth audio transmission contain the PIN; verifying the PIN at the third computing device; and transmitting, from the second computing device, a fifth audio transmission containing an approval.

In a fifteenth aspect according to the fourteenth aspect, the techniques described herein relate to a method, further including, at the first computing device: submitting a request to an online commerce platform; and receiving, from the online commerce platform, the request identifier.

In a sixteenth aspect according to the fifteenth aspect, the techniques described herein relate to a method, wherein the third computing device is a computing device associated with the online commerce platform.

In a seventeenth aspect according to at least one of the fifteenth and sixteenth aspects, the techniques described herein relate to a method, wherein the second device identifier was received by the third computing device before submitting the request.

In an eighteenth aspect according to at least one of the fifteenth through seventeenth aspects, the techniques described herein relate to a method, wherein submitting the request includes submitting the first device identifier.

In a nineteenth aspect according to at least one of the fourteenth through eighteenth aspects, the techniques described herein relate to a method, further including, at the first computing device: performing a biometric scan of the user; and generating the first device identifier based on the biometric scan.

In a twentieth aspect according to at least one of the fourteenth through nineteenth aspects, the techniques described herein relate to a method, wherein the first device identifier is generated based on a unique identifier of the second computing device.

In a twenty-first aspect according to the twentieth aspect, the techniques described herein relate to a method, wherein the first computing device is one of a plurality of computing devices associated with the user, and wherein a plurality of device identifiers are stored in association with the request identifier.

In a twenty-second aspect according to the twenty-first aspect, the techniques described herein relate to a method, wherein the second device identifier is selected from among the plurality of device identifiers.

In a twenty-third aspect according to any of the fourteenth through twenty-second aspects, the techniques described herein relate to a method, wherein the beacon signal identifies the second computing device as capable of transmitting and receiving audio transmissions containing data.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system according to an exemplary embodiment of the present disclosure.

FIG. 2 illustrates an audio transmission according to an exemplary embodiment of the present disclosure.

FIG. 3 illustrates a scenario according to an exemplary embodiment of the present disclosure.

FIG. 4 illustrates a scenario according to an exemplary embodiment of the present disclosure.

FIG. 5 illustrates an audio channel distribution according to an exemplary embodiment of the present disclosure.

FIG. 6 illustrates a system according to an exemplary embodiment of the present disclosure.

FIG. 7 illustrates a system according to an exemplary embodiment of the present disclosure.

FIG. 8 illustrates a method according to an exemplary embodiment of the present disclosure.

FIG. 9 illustrates a method according to an exemplary embodiment of the present disclosure.

FIG. 10 illustrates a flow diagram of a method according to an exemplary embodiment of the present disclosure.

FIG. 11 illustrates a flow diagram of a method according to an exemplary embodiment of the present disclosure.

FIG. 12 illustrates a computing system according to an exemplary embodiment of the present disclosure.

### DETAILED DESCRIPTION OF EXAMPLE EMBODIMENTS

Aspects of the present disclosure relate to transmitting and receiving audio transmissions between multiple devices. In certain aspects, a computing device may receive an audio transmission from a nearby computing device attempting to redeem a request for a service and may verify whether the nearby computing device is actually associated with the request for service.

Various techniques and systems exist to exchange data between computing devices located near one another without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency identification (RFID), Near Field Communication (NFC), and Wi-Fi® (e.g., direct Wi-Fi® links between the computing devices). However, each of these protocols relies on data transmission using electromagnetic waves at various frequencies. Therefore, in certain instances (e.g., Zig Bee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired to transmit data according to these wireless communication protocols. Such communicative pairing can be cumbersome and slow, reducing the likelihood that users associated with one or both of the computing devices will utilize the protocols to transmit data.

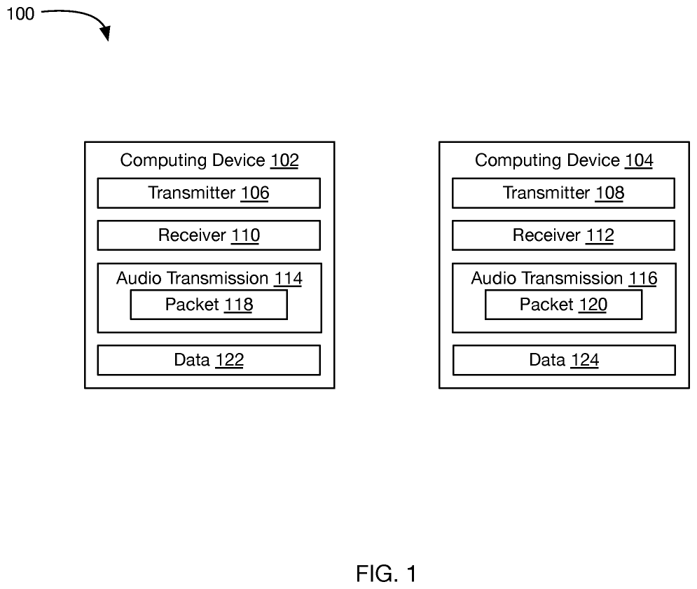

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an exemplary embodiment of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers or transducers. In certain implementations, the transmitters 106, 108 may be implemented as a speaker built into the computing device 102, 104. For example, one or both of the computing devices may be a smart phone, tablet computer, and/or laptop with a built-in speaker that performs the functions of the transmitter 106, 108. In other implementations, the transmitters 106, 108 may be implemented as a speaker or transducer external to the computing device 102, 104. For example, the transmitters 106, 108 may be implemented as one or more speakers or transducers externally connected to the computing device 102, 104. In still further implementations, transmitters 106, 108 may be communicatively separate from computing devices.

The receivers 110, 112 may include any type of device capable of receiving audio transmissions and converting the audio transmissions into signals (e.g., digital signals) capable of being processed by a processor of the computing device, such as microphones. In other implementations, the receivers 110, 112 may be implemented as a microphone built into the computing devices 102, 104. For example, one or both of the computing devices may be a smartphone, tablet computer, and/or laptop with a built-in microphone that performs the functions of the receivers 110, 112. In other implementations, the receivers 110, 112 may be implemented as a microphone external to the computing devices 102, 104. For example, the receivers 110, 112 may be implemented as one or more microphones external to the computing devices 102, 104 that are communicatively coupled to the computing devices 102, 104. In certain implementations, the transmitters 106, 108 and receivers 110, 112 may be implemented as a single device connected to the computing device. For example, the transmitters 106, 108 and receivers 110, 112 may be implemented as a single device containing at least one speaker and at least one microphone that is communicatively coupled to the computing devices 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112. In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing device 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmissions 114, 116, the computing devices 102, 104 may modulate the packets 118, 120 onto an audio carrier signal. The computing devices 102, 104 may then transmit the audio transmissions 114, 116 via the transmitters 106, 108, which may then be received by the receivers 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Also, because these techniques can utilize conventional computer hardware like speakers and microphones, the computing devices 102, 104 do not require specialized hardware to transmit the data 122, 124.

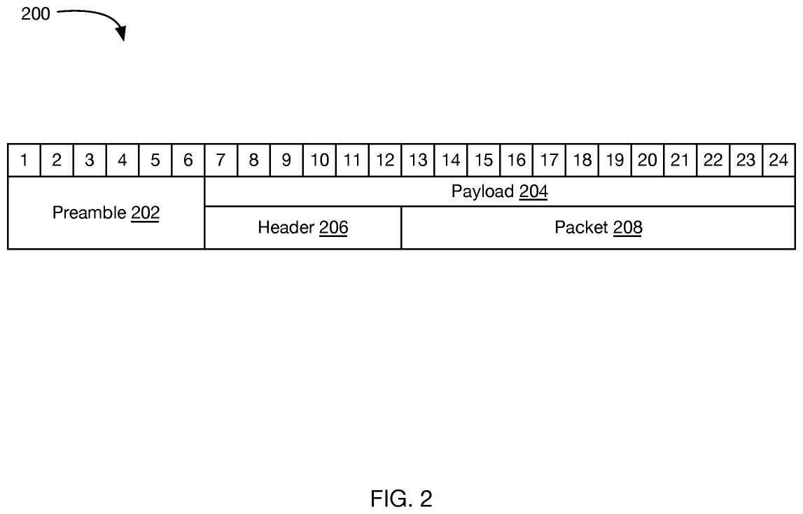

FIG. 2 illustrates an audio transmission 200 according to an exemplary embodiment of the present disclosure. The audio transmission 200 may be used to transmit data from one computing device to another computing device. For example, referring to FIG. 1, the audio transmission 200 may be an example implementation of the audio transmissions 114, 116 generated by the computing devices 102, 104. The audio transmission 200 includes multiple symbols 1-24, which may correspond to discrete time periods within the audio transmission 200. For example, each symbol 1-24 may correspond to 2 ms of the audio transmission 200. In other examples, the symbols 1-24 may correspond to other time periods within the audio transmission 200 (e.g., 1 ms, 10 ms, 20 ms, 40 ms). Each symbol 1-24 may include one or more frequencies used to encode information within the audio transmission 200. For example, the one or more frequencies may be modulated to encode information in the audio transmission 200 (e.g., certain frequencies may correspond to certain pieces of information). In another example, the phases of the frequencies may additionally or alternatively be modulated to encode information in the audio transmission 200 (e.g., certain phase differences from a reference signal may correspond to certain pieces of information).

In particular, certain symbols 1-24 may correspond to particular types of information within the audio transmission 200. For example, the symbols 1-6 may correspond to a preamble 202 and symbols 7-24 may correspond to a payload 204. The preamble 202 may contain predetermined symbols produced at predetermined points of time (e.g., by varying one or more of the frequency and the phase in a predetermined manner for the frequencies 1-6). The preamble 202 may be used to identify the audio transmission 200 to a computing device receiving the audio transmission 200. For example, a receiver of the computing device receiving audio transmissions, such as the audio transmission 200, may also receive other types of audio data (e.g., audio data from environmental noises and/or audio interference). The preamble 202 may therefore be configured to identify audio data corresponding to the audio transmission 200 when received by the receiver of the computing device. In particular, the computing device may be configured to analyze incoming audio data from the receiver and to disregard audio data that does not include the preamble 202. Upon detecting the preamble 202, the computing device may begin receiving and processing the audio transmission 200. The preamble may also be used to align processing of the audio transmission 200 with the symbols 1-24 of the audio transmission 200. In particular, by indicating the beginning of the audio transmission 200, the preamble 202 may enable the computing device receiving the audio transmission 200 to properly align its processing of the audio transmission with the symbols 1-24.

The payload 204 may include the data intended for transmission, along with other information enabling proper processing of the data intended for transmission. In particular, the packet 208 may contain data desired for transmission by the computing device generating the audio transmission 200. For example, and referring to FIG. 1, the packet 208 may correspond to the packets 118, 120 which may contain all or part of the data 122, 124. The header 206 may include additional information for relevant processing of data contained within the packet 208. For example, the header 206 may include routing information for a final destination of the data (e.g., a server external to the computing device receiving the audio transmission 200). The header 206 may also indicate an originating source of the data (e.g., an identifier of the computing device transmitting the audio transmission 200 and/or a user associated with the computing device transmitting the audio transmission 200).

Symbols 1-24 and their configuration depicted in FIG. 2 are merely exemplary. It should be understood that certain implementations of the audio transmission 200 may use more or fewer symbols, and that one or more of the preamble 202, the payload 204, the header 206, and/or the packet 208 may use more or fewer symbols than those depicted and may be arranged in a different order or configuration within the audio transmission 200.

The techniques described above may be used to improve the provisioning of location-based services that require one or more users to be in a particular location, such as transportation services, product pick-up, delivery services, or other location-based services (e.g., dog walking services). Software platforms exist that allow users to request such services from a computing device, such as a smartphone or personal computer. Users may then need to be in particular locations to redeem a request. For example, when a user requests transportation by a vehicle, the user may interact with a vehicle and/or an operator of a vehicle to enter the vehicle and be transported to their destination. As another example, for delivery services such as food delivery services, a driver of a vehicle may first interact with an employee of a restaurant to pick up food and may later interact with a customer who purchased the food to deliver the food. As a further example, a user may order a product for pick-up from a particular location (e.g., a retail store) and may need to be verified (e.g., to confirm their identity and associated order) before the order can be picked up.

In these instances, users are typically required to manually confirm they are in the proper location and may need to be manually verified. For example, when a user is picked up for transportation, the user may have to identify a corresponding vehicle by license plate. As another example, when a driver is picking up food for delivery, the driver may have to request a specific order to receive the proper food for delivery. As a further example, a user picking up an item from a retail location may need to find a store employee and provide the store employee with identifying information (e.g., an order number, an ID card for the user) so that the store employee can look up and confirm the correct information on the store's computer system. These systems may be important for both ensuring that the user receives the correct product or service and for preventing fraudulent claims that users did not receive service (e.g., via a transportation application, via card payment networks). Such systems can be error prone, as users may mistakenly enter the wrong vehicle, drivers may be provided with an incorrect food order, and/or employees or customers may enter the wrong order number. In certain instances, the software platforms may provide a single use passcode (e.g., a 4-8 digit numeric passcode, an alphanumeric passcode) to one user (e.g., a passenger) that the user may provide to another user (e.g., a driver). The other user may enter the passcode into their computing device to verify whether the user is the correct user for a particular request (e.g., whether the right passenger entered the car). These solutions can be cumbersome, however, as users have to provide the codes to one another, which can be tedious and slow, and which can also introduce errors. Therefore, the software platforms may typically only use such verification systems at busy locations (e.g., at airports, busy restaurants, busy stores, and/or at busy times). Such restrictions, however, leave many other situations unverified, which can delay the provisioning of services and/or create security risks (e.g., of passengers getting into unauthorized vehicles, of users receiving the wrong goods). Therefore, there exists a need to automatically identify when computing devices associated with service requests are located near one another.

One solution to this problem is to use audio transmissions to transmit authenticating information from one computing device to another. Audio transmissions may typically only be successfully transmitted between computing devices that are located near one another. Therefore, if a computing device receives an audio transmission from another computing device, the two computing devices are likely located near one another. The computing device receiving the audio transmission can then use the received information to verify whether the computing device that transmitted the audio transmission is properly associated with a request for service or a product. For example, the computing device may communicate with a merchant (e.g., a merchant providing the requested service or product) to verify the provided information. For added security, a user may also be required to provide a PIN to confirm that the user is actually present to redeem the request. As another example, the computing device may receive a copy of the PIN or expected payload necessary to verify the user. In such instances, rather than communicating with the merchant, the computing device may itself perform verification of the user (e.g., on premises).

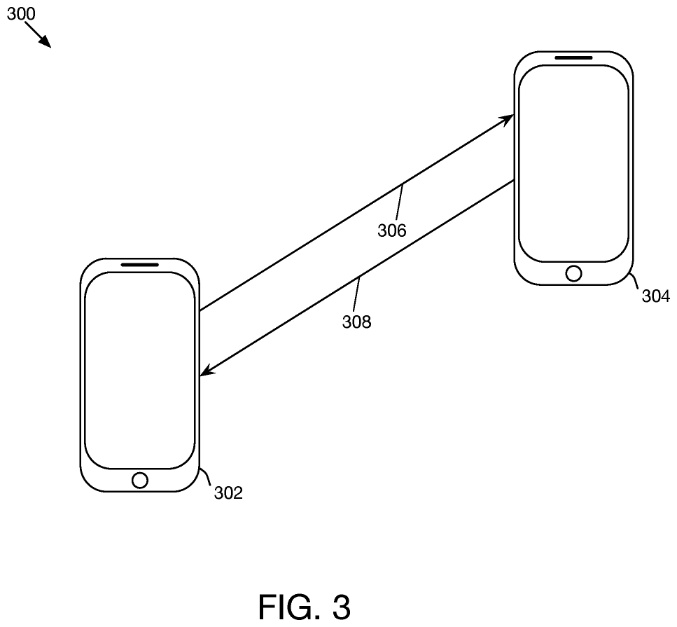

FIG. 3 illustrates a scenario 300 according to an exemplary embodiment of the present disclosure. In the scenario 300, a computing device 302 transmits an audio transmission 306 to the computing device 304. The computing device 304 also transmits an audio transmission 308 to the computing device 302. As depicted, both of the computing devices 302, 304 are mobile devices (e.g., smartphones). Accordingly, the audio transmissions 306, 308 may be transmitted using speakers of the mobile devices and may be received using microphones of the mobile devices. In certain implementations, the audio transmissions 306, 308 may be transmitted at different times. For example, the computing device 302 may transmit the audio transmission 306 before the computing device 304 transmits the audio transmission 308. In other implementations, the audio transmissions 306, 308 may be transmitted at least partially at the same time. In such instances, the audio transmissions 306, 308 may be transmitted on different channels (e.g., using different carrier frequencies), as explained further below.

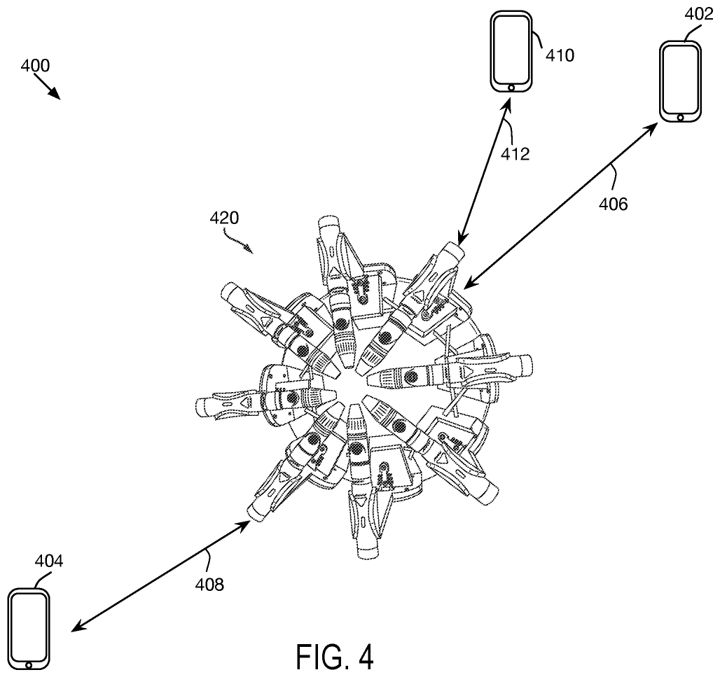

FIG. 4 illustrates another scenario 400 according to an exemplary embodiment of the present disclosure. The scenario 400 includes multiple computing devices 402, 404, 410 communicating with a transmitter/receiver array 420. The transmitter/receiver array 420 includes multiple audio transmitters (e.g., multiple speakers) and multiple audio receiver (e.g., multiple microphones). The transmitter/receiver array 420 may thus be capable of communicating with multiple computing devices 402, 404, 410 at the same time. For example, the transmitter/receiver array 420 may transmit an audio transmission 406 to the computing device 402, receive an audio transmission 412 from the computing device 410, and receive an audio transmission 408 from the computing device 404. In certain instances, the same receiver may receive audio transmissions from multiple computing devices and/or the same speaker may transmit audio transmissions to multiple computing devices. In such instances, different audio channels may be used to transmit and/or receive audio transmissions (e.g., to avoid interference between different communication channels).

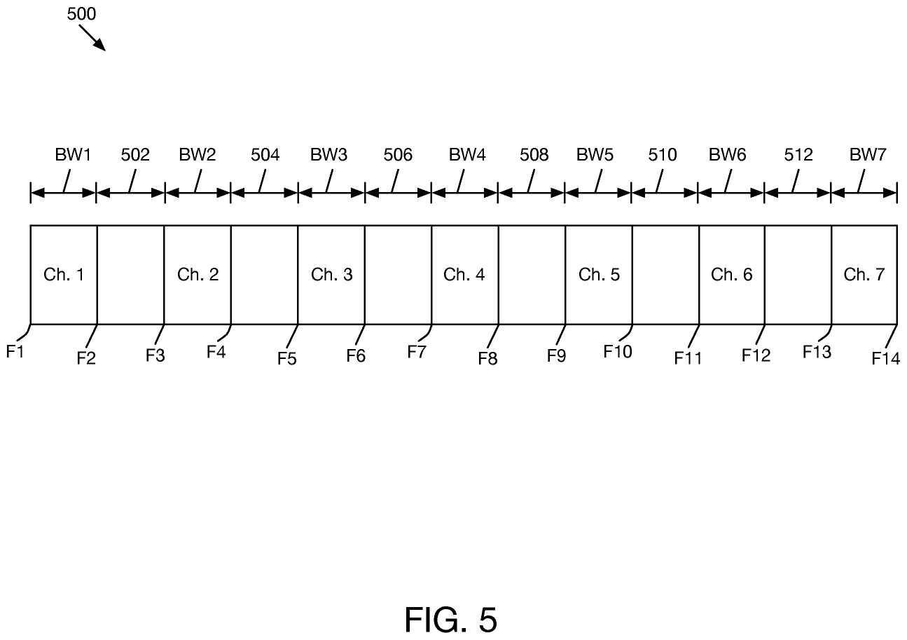

For example, FIG. 5 illustrates an audio channel distribution 500 according to an exemplary embodiment of the present disclosure. The audio channel distribution 500 includes audio channels 1-7 distributed along a frequency spectrum F1-F15. Each audio channel 1-7 has a corresponding bandwidth BW1-7. In particular, audio channel 1 has a bandwidth BW1 spanning from F1 to F2, audio channel 2 has a bandwidth BW2 spanning from F3 to F4, audio channel 3 has a bandwidth BW3 spanning from F5 to F6, audio channel 4 has a bandwidth BW4 spanning from F7 to F8, audio channel 5 has a bandwidth BW5 spanning from F9 to F10, audio channel 6 has a bandwidth BW6 spanning from F11 to F12, and audio channel 7 has a bandwidth BW7 spanning from F13 to F14. The audio channels 1-7 may represent a range of carrier frequencies that can be used to transmit audio transmissions. For example, to transmit an audio transmission according to an audio channel 1, a computing device may utilize a carrier frequency between F1 and F2. In certain implementations, the computing device may use a carrier frequency halfway between F1 and F2. As a specific example, where F1 is 9.5 kHz and F2 is 10.5 kHz, a computing device transmitting an audio transmission using audio channel 1 may utilize a carrier frequency between 9.8 and 10.2 kHz, such as 10 kHz.

The audio channels 1-7 are also separated by frequency bands 502, 504, 506, 508, 510, 512. In particular, frequency band 502 separates audio channels 1 and 2 and spans from frequency F2 to F3, frequency band 504 separates audio channels 2 and 3 and spans from frequency F4 to F5, frequency band 506 separates audio channels 3 and 4 and spans from frequency F6 to F7, frequency band 508 separates audio channels 4 and 5 and spans from frequency F8 to F9, frequency band 510 separates audio channels 5 and 6 and spans from frequency F10 to F11, and frequency band 512 separates audio channels 6 and 7 and spans from frequency F12 to F13. The frequency bands 502, 504, 506, 508, 510, 512 may separate the audio channels 1-7, which may help prevent audio transmissions from interfering with one another. For example, inaccuracies in the transmitters of computing devices (e.g., inaccuracies in the clock synchronization of the computing devices) may result in audio transmissions with inaccurate carrier frequencies (e.g., carrier frequencies that deviate from desired or preferred carrier frequencies within a given audio channel 1-7). As another example, interference with an audio transmission (e.g., movement of the computing device while transmitting the audio transmission) may shift or otherwise alter the carrier frequency of the audio transmission when it is received. In either of these instances, the changes to the carrier frequency may cause all or part of the audio transmission to occur outside of a desired audio channel. As a specific example, where a computing device is using audio channel 2, the audio transmission may include portions that have a higher frequency than F3 and/or a lower frequency than F2. In such instances, if the frequency bands 502, 504 were not separating the audio channel 2 from the audio channels 1, 3, the audio transmission may overlap with one of the audio channels 1, 3, interfering with audio transmissions in the audio channels 1, 3. Therefore, the frequency bands 502, 504, 506, 508, 510, 512 may help improve the accuracy of received transmissions by reducing and/or preventing audio transmission interference across channels.

In certain implementations, the audio channels 1-7 may have equal bandwidths BW1-7. For example, each of the bandwidths 1-7 may be 1 kHz wide, although other implementations may also be used (e.g., bandwidths of 500 Hz, 2 kHz, 5 kHz). In additional or alternative implementations, the audio channels 1-7 may have different bandwidth BW1-7. Additionally, in certain implementations, the frequency bands 502, 504, 506, 508, 510, 512 may be of equal width. For example, each of the frequency bands 502, 504, 506, 508, 510, 512 may be 1 kHz wide, although other implementations may also be used (e.g., frequency bands of 500 Hz, 2 kHz, 5 kHz). In further implementations, the frequency bands 502, 504, 506, 508, 510, 512 may have different widths.

In certain implementations, the bandwidths BW1-7 and frequency bands 502, 504, 506, 508, 510, 512 may have the same width. For example, the bandwidths BW1-7 and frequency bands 502, 504, 506, 508, 512 may all have a width of 1 kHz. In such instances, frequency F1 may be 9.5 kHz, frequency F2 may be 10.5 kHz, frequency F3 may be 11.5 kHz, frequency F4 may be 12.5 kHz, frequency F5 may be 13.5 kHz, frequency F6 may be 14.5 kHz, frequency F7 may be 15.5 kHz, frequency F8 may be 16.5 kHz, frequency F9 may be 17.5 kHz, frequency F10 may be 18.5 kHz, frequency F11 may be 19.5 kHz, frequency F12 may be 20.5 kHz, frequency F13 may be 21.5 kHz, and frequency F14 may be 22.5 kHz.

It should also be understood that alternative embodiments of the audio channel distribution 500 may use additional or fewer channels. For example, the alternative implementations may include 10 audio channels. As another example, alternative implementations may include five or six audio channels. In particular, instead of utilizing two audio channels 1-2 as control channels, only audio channel 1 may be used as a control channel, which may therefore result in six total audio channels (e.g., audio channel 7 may not be used). In still further implementations, no control channel may be used, resulting in five total audio channels (e.g., audio channels 6, 7 may not be used).

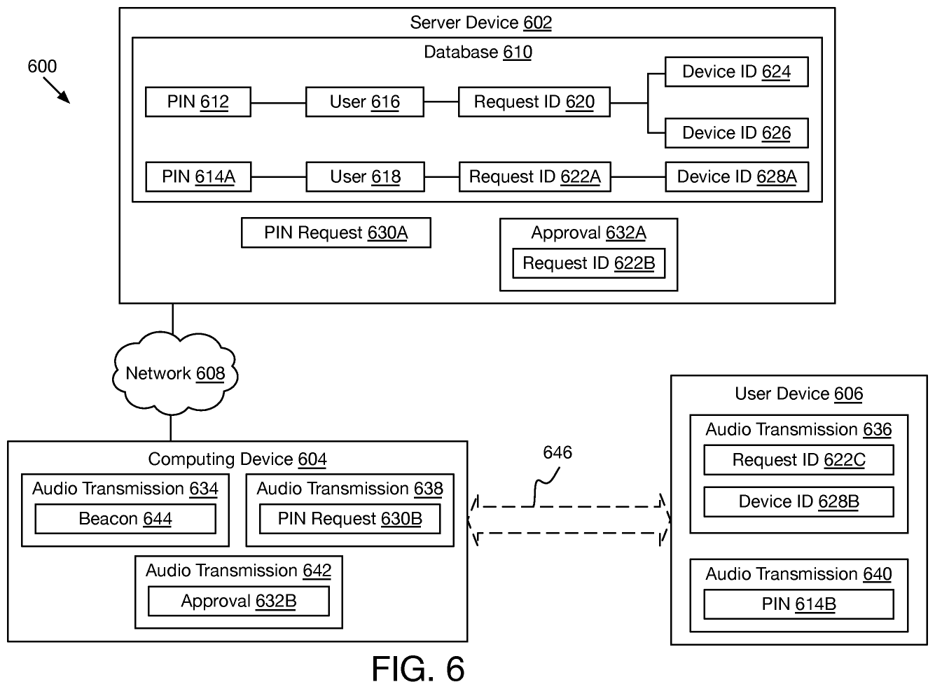

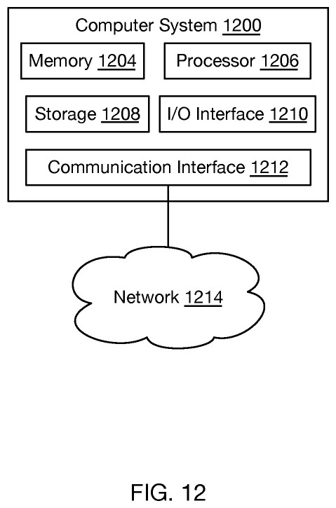

FIG. 6 illustrates a system 600 according to an exemplary embodiment of the present disclosure. The system 600 may be configured to coordinate communication between multiple computing devices to verify attempts to redeem requests for products or services. In particular, the system 600 includes a server device 602, a computing device 604, and a user device 606. In practice, all three devices 602, 604, 606 may be implemented by computing systems, as discussed further below in connection with FIG. 12. The devices 602, 604, 606 may communicate to associate the user device 606 with a request for a service received by the server device 602. In particular, a system 600 may associate with the user device 606 when the user device 606 has arrived in the location (e.g., to receive a product or service associated with the request). The devices 602, 604, 606 may communicate using various interfaces. In particular, the server device 602 and the computing device 604 communicate using a network 608, which may represent a local network (e.g., a local area network), a virtual private network, L1, and/or a global network (e.g., the Internet). The computing device 604 and the user device 606 may communicate within an audio environment 646. The audio environment 646 may represent a physical environment containing the computing device 604 and the user device 606. Audio transmissions may be exchanged between the computing device 604 and the user device 606, as discussed further below.

The server device 602 may represent a computing device associated with a merchant. As used herein, a “merchant” may refer to a retailer or other seller of physical goods, a restaurant or other seller of food products, and/or a service provider that provides access to a service platform for location-based services. “Location-based services” may include any service that requires one or more parties (e.g., the requester of the service, the provider of the service) to be in or near a particular location to receive and/or provide the service. Example location-based services may include a delivery service for food or retail products, an order platform that allows customers to pick up a product ordered online from a location (e.g., a retail store, a restaurant, a product warehouse), a transportation service (e.g., a rideshare service, public transportation service), a home cleaning service, a dog walking service, and the like.

In certain implementations, the server device 602 may represent a point-of-sale (POS) device associated with a retail store. As another example, the server device 602 may represent a server or other computing device that provides access to an online service platform (e.g., an online commerce platform, an online rideshare platform, and the like). The server device 602 includes a database 610 that stores information regarding requests for services or products received by the merchant. In particular, the database 610 stores request identifiers (IDs) 620, 622A associated with requests received from user devices. For example, the user device 606 may have previously submitted a request for a product or service associated with the request ID 622A. In one specific example, the server device 602 may be a server providing an online commerce platform and a user associated with the user device 606 may have submitted an order for a product for in-person pickup (e.g., at a retail store location) associated with the request ID 622A. The database 610 also stores additional information associated with the request IDs 620, 622A. The database 610 stores indications of the users 616, 618 associated with the request IDs 620, 622A, which may indicate an email, username, or other unique identifier of the user who submitted the requests. The database further stores PINs 612, 614A that are associated with the users 616, 618. The PINs 612, 614A may represent private, unique identifiers of the users 616, 618 used to authenticate or otherwise verify the users 616, 618. In certain implementations, the PINs 612, 614A may include a unique alphanumeric identifier or password provided by the user. Additionally or alternatively, the PINs 612, 614A may include a biometric identifier of the users 616, 618, such as one or more of fingerprint scan(s) of the users 616, 618, facial scan(s) of the users 616, 618, voice recordings of the users 616, 618, iris scans of the users 616, 618, and the like. In certain implementations, the biometric identifier may be hashed or otherwise manipulated to generate the PINs 612, 614A. The database 610 also stores device identifiers (IDs) 624, 626, 628A associated with the request IDs 620, 622A. The device IDs 624, 626, 628A may uniquely identify one or more computing devices associated with the request. In particular, the database 610 may store device IDs 624, 628A that uniquely identify a user device that submitted the request associated with the request IDs 620, 622A. For example, the device IDs may be generated based on one or more of a location of the user device when the request was created, a MAC address of the user device, a UUID associated with the user device, a clock time of the user device when the request was created, a pressure sensor value of the user device when the request was created, an ambient noise level detected by the user device when the request was created, and/or a unique value received from the server device upon logging into an account associated with the user from the user device. As explained further below, the device IDs 624, 626, 628 may be used to verify that the same user device 606 used to submit a request is present when an individual attempts to pick up the product or receive the service. In certain implementations, the merchant database 610 may also store device IDs 626 for other computing devices associated with a user who submitted the order. For example, the user 616 may have submitted a request using the user device associated with the device ID 624, but may have registered multiple devices with the server device 602 (e.g., by logging in from multiple computing device and/or authorizing multiple computing devices for use). In response, device IDs 626 may be generated for the additional computing devices and stored in association with the request ID 620 and/or the user 616. In certain implementations, the user 616 may add device IDs by registering computing devices associated with other individuals (e.g., family members, employees, fiduciaries, and the like). In this way, other user devices and/or other individuals may redeem requests for products or services. In one example, the user 616 may have submitted a request for a product from their computer but wants to pick up the product using their phone. In another example, the user 616 may request a product for pickup by a family member, who can then use their own phone to pick up the product.

The server device 602 also includes a PIN request 630A and an approval 632A. As explained further below, these may be transmitted to the computing device 604 (e.g., via the network 608) for communication between the computing device 604 and the user device 606 to verify and securely associate the user device 606 with a particular request ID 622A.

The computing device 604 may be configured to communicate with the user device 606 via the audio environment 646 on behalf of the server device 602. In certain implementations, the computing device 604 may be implemented by a point-of-sale device. The computing device 604 may be located within a facility at which a user associated with the user device 606 may redeem a request for a location-based service. As an example, the user may request or provide a location-based service and the computing device 604 may be located at a location where the user can receive or act on the location-based service (e.g., receive transportation via a rideshare vehicle, walk a dog at the request of a user of a dog walking platform). As another example, the user may order a product or meal and the computing device 604 may be located at a location where the user (e.g., or delivery driver) can pick up the product (e.g., at a retail facility, at a restaurant, at a shipping warehouse).

In certain implementations, the computing device 604 may be configured to output an audio signal that indicates to other computing devices (e.g., user devices) that the computing device 604 is located nearby and is configured to receive and transmit audio transmissions. In particular, the computing device 104 may transmit an audio transmission 634 containing a beacon 644. The beacon 644 may include a predetermined audio sequence (e.g., a predetermined audio signal and/or one or more predetermined symbols within an audio transmission). Upon extracting the beacon 644 from the audio transmission 634, other computing devices, such as the user device 606, may determine that communications may be exchanged using audio transmissions via the audio environment 646.

Furthermore, the beacon 644 may indicate that the process of authenticating a user and associating the user device 606 with a particular request for a service may be completed. For example, in response to receiving an audio transmission 634 containing a beacon 644, the user device 606 may determine that the user device 606 is located near a location where the request for service may be redeemed or fulfilled (e.g., where an order may be picked up, where the user can enter a rideshare vehicle). In certain implementations, the user device 606 may further confirm the user device 606′s location using a location sensor (e.g., a GPS sensor, a cellular location) to confirm that the user device 606 is in a location associated with a request for service (e.g., a request for service submitted by the user device 606).

The user device 606 may then proceed to communicate with the computing device 604 to verify and securely associate the user device 606 with a particular request ID 622A. As explained in greater detail below, the computing device 604 and the user device 606 may exchange multiple audio transmissions 636, 638, 640, 642 to verify a user of the user device 606 and identify the corresponding request ID 622A within the database 610. In particular, the computing device 604 may communicate with the server device 602 via the network 608 while exchanging audio transmissions to receive information associated with a particular request ID.

In one specific example, the user device 606 may transmit an audio transmission 636 containing a request ID 622C (which may be a copy of the request ID 622A) and a device ID 628B (which may be a copy of the device ID 628A). The user device 606 may have received the request ID 622C when submitting a request to the server device 602. The user device 606 may generate the device ID 628B prior to transmission of the audio transmission 636. For example, the user device 606 may generate the device ID 628B in response to detecting the beacon 644. The device ID 628B may be generated based on a unique identifier of the user device 606, as explained above. Additionally or alternatively, the device ID 628B may be generated based on a biometric scan (e.g., a facial scan, fingerprint scan, iris scan, voice detection, and the like) of a user associated with the user device 606. In such instances, the user device 606 may prompt the user for the biometric scan (e.g., a biometric scan performed by the user device) to generate the device ID 628B. In certain implementations, the user device 606 may instead have previously stored the device ID 628B. In such instances, rather than regenerating the device ID 628B, the user device 606 may retrieve the stored copy of the device ID 628B. The user device 606 may then generate the audio transmission by modulating the data representing the request ID 622C and the device ID 628B onto a payload (e.g., a payload 204) of an audio signal representing the audio transmission 636. In certain implementations, the payload may be defined by a merchant associated with the server device 602. For example, the merchant may specify a particular format for the request ID and/or the device ID. In certain implementations, the merchant may specify how device IDs are generated. Furthermore, the merchant may specify how the request ID 622C and the device ID 628B are stored within the payload. The user device 606 may then transmit the audio transmission 636 as an audio signal within the audio environment 646 using a transmitter (e.g., a speaker located on the user device 606).

In response to receiving the audio transmission 636, the computing device 604 may communicate with the server device 602. In particular, the computing device 604 may provide the request ID 622C and the device ID 628B to the server device 602 for verification. The server device 602 may compare the request ID 622C to other request IDs stored within the database 610. The server device 602 may determine that the request ID 622C is equivalent to the request ID 622A. The server device 602 may then confirm whether the device ID 628B received from the user device 606 matches a device ID stored in association with the identified request ID 622A. In the depicted example, the device ID 628B is equivalent to the device ID 628A, and the server device 602 may determine that the user device 606 has provided a valid request ID 622C and a valid device ID 628B. In response, the server device 602 may generate a PIN request 630A requesting that the user provide a PIN for authentication. The server device 602 may transmit the PIN request 630A via the network 608 to the computing device 604, which may generate an audio transmission 638 containing a PIN request 630B (which may be a copy of the PIN request 630A). For example, the computing device 604 may modulate data representing the PIN request 630B onto an audio signal (e.g., within a payload 204). Computing device 604 may then transmit the audio transmission 638 into the audio environment 646 (e.g., using a speaker or other audio transmitter communicatively coupled to or included within the computing device 604). In certain embodiments, the server device 602 may generate and transmit items other than the PIN request 630A (or instead of the PIN request 630A). For example, the server device may transmit an order ID and/or authentication verification data (e.g., to indicate that the PIN request 630A is genuine).

After receiving the audio transmission 638, the user device 606 may extract the PIN request 630B and, in response, may present a request to a user of the user device 606 to enter a PIN (e.g., via a graphical user interface presented on a display of the user device 606). In response, the user may enter a PIN 614B. The PIN may include one or more alphanumeric characters and/or one or more biometric scans of the user. The user may use a graphical user interface to enter the PIN 614B into the user device 606 (e.g., where the PIN 614B includes one or more alphanumeric characters). Additionally or alternatively, the user may interact with one or more biometric scanners of the user device 606 (e.g., fingerprint scanners, facial scanners, iris scanners) to generate the PIN 614B where the PIN is generated at least in part based on the biometric scan of the user. In certain implementations, the PIN 614B may be hashed, encrypted, or otherwise obfuscated before being added to the audio transmission 640. For example, the PIN 6148 may be encrypted using a public key of the server device 602 and/or the computing device 604 (e.g., received with the PIN request 630B, receiving the user device 606 submitted the request). Additionally or alternatively, the PIN 614B may be encrypted using the request ID 622C and/or the device ID 628B. In still further embodiments, the exchange may be hashed using a pre-shared hash seed (e.g., exchanged when the request was originally created). The audio transmission 640 may then be generated and transmitted into the audio environment 646 similar to the audio transmission 636.

After receiving the audio transmission 640, the computing device 604 may transmit the PIN 614B via the network 608 to the server device 602 for verification. The server device 602 may receiving compare the PIN 614B from the user device 606 to a PIN 614A associated with the user 618 that submitted the request and the request ID 622A. For example, the server device 602 may compare the PINs 614A, 614B to determine whether the PINs 614A, 614B are identical. Where the PIN 614B has been hashed, encrypted, or obfuscated, the server device 602 may perform similar obfuscations on the PIN 614A and may compare the results. For example, the PIN 614B may be hashed with a copy of the request ID 622C in the device ID 628B by the user device 606. To compare, the server device 602 may similarly hash the PIN 614A using the request ID 622A and the device ID 628A and may compare the hashed PIN 614A to the hashed PIN 614B. As another example, the PIN 614B may be encrypted using a public key associated with the server device 602. Upon receiving the PIN 6148, the server device 602 may decrypt the PIN 614B using a private key associated with the server device 602. The server device 602 mailing compare the PIN 614A with the decrypted PIN 614B. If the server device 602 determines that the PINs 614A, 614B are equivalent, the server device 602 may create an approval 632A indicating that the user device 606 has been verified and securely associated with the request ID 622A. The approval 632A may include a request ID 622B (which may be a copy of the request ID 622A). The server device 602 may transmit the approval 632A of the computing device 604 via the network 608. The computing device 604 may then generate an audio transmission 642 containing the approval 632B (which may be a copy of the approval 632A). The computing device 604 may then transmit the audio transmission 642 into the audio environment 646 using techniques similar to those discussed above for audio transmission 638.

In response to receiving the audio transmission 642, the user device 606 may determine that the user device 606 has been verified and securely associated with the request ID 622B included within the approval 632B. Accordingly, the user device 606 may proceed with fulfilling the request associated with the request ID 622A. For example, where the request is associated with a location-based service, the user device 606 may proceed with fulfilling the service (e.g., with instructing the user to enter a rideshare vehicle). As another example, where the request is to pick up a product, the user device 606 and/or the computing device 604 may indicate authorization to pick up the product to an employee of the facility in which the computing device 604 located (e.g., a product warehouse, a retail location). In response, the product may be provided to the user, completing the location-based service. In additional or alternative implementations, in response to the approval 632B, the user device 606 may be authorized to communicate directly with the server device 602 via the network 608. For example, the approval 632B may further include a network address or other communication parameters (e.g., an API endpoint, a domain name, and the like) that may be used to communicate with the server device 602 and/or other communication devices associated with the merchant. The user device 606 may then continue communicating with the merchant directly via the network 608.

As explained above, one or more of the server device 602, the computing device 604, and the user device 606 may be communicatively coupled to the network 608. These devices 602, 604, 606 may communicate with the network 608 using one or more wired network interfaces (e.g., Ethernet interfaces) and/or wireless network interfaces (e.g., Wi-Fi®, Bluetooth®, and/or cellular data interfaces).

The server device 602 and the computing device 604 are depicted as separate computing devices that communicate using a network 608. However, in certain implementations, the server device 602 and the computing device 604 may be implemented as a single computing device. In such instances, the computing device 604 may store a copy of all or part of the database 610 and may generate the PIN request 630A and the approval 632A. In further implementations, the server device 602 and the computing device 604 may be implemented as separate computing devices, but the PIN request 630A and the approval 632A may be generated by the computing device 604. For example, upon receiving the request ID 622A, the server device 602 may provide a copy of the request ID 622A and all associated information (e.g., the PIN 614A, the user 618, and the device ID 628A) to the computing device 604. Based on the received information, the computing device 604 may verify the request ID 622C, the device ID 628B, and the PIN 614B received from the user device 606. The computing device 604 may also generate the PIN request 630A and the approval 632A while verifying this information. In light of the present disclosure, other, similar implementation of the above-discussed techniques using one or more computing devices may be readily apparent to one skilled in the art. All such implementations are hereby contemplated within the scope of the present disclosure.

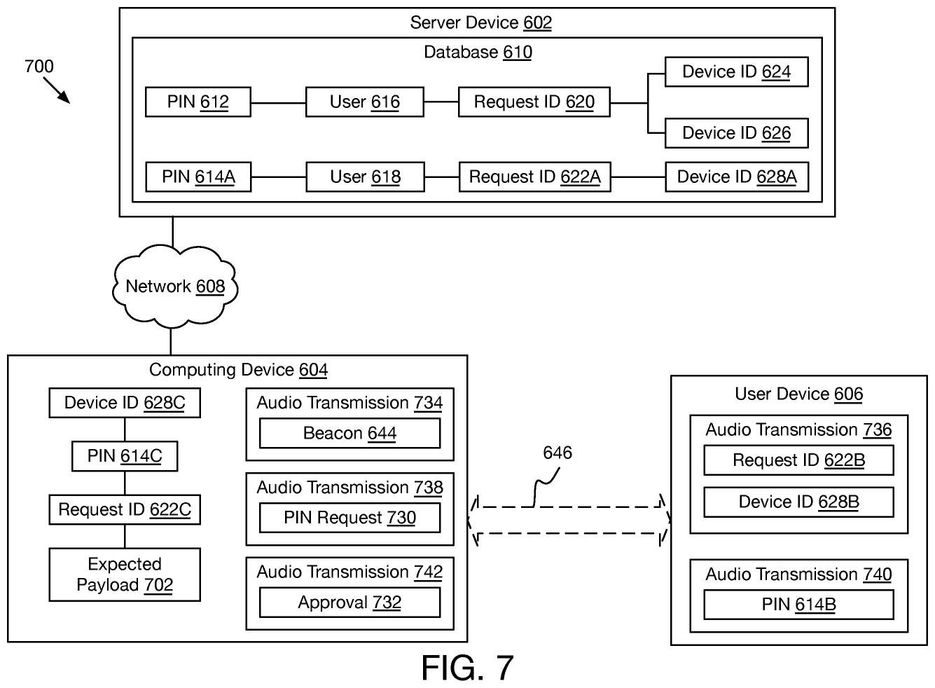

For example, FIG. 7 illustrates a system 700 according to an exemplary embodiment of the present disclosure. In particular, the system 700 may be an exemplary alternative implementation of the system 600 that does not rely on the server device 602 to perform PIN or user authentication. Accordingly, similar to the system 600, the system 700 includes the server device 602, the computing device 604, and the user device 606, which may respectively be exemplary or alternative implementations of these server device 602, the computing device 604, in/ or the user device 606 within the system 600.

Notably, the server device 602 contains a database 610 that includes the PIN 614A, the user 618, the request ID 622A, and/ or the device ID 628A, which may be generated or received from the user device 606 (or another computing device associated with the same user) when originating a request (e.g., a request for a service), as explained above. Upon receiving the PIN 614A, the device ID 628A, the request ID 622A, the server device 602 may transmit copies to the computing device 604 (received as PIN 614C, device ID 628C, and request ID 622C). The computing device 604 may then construct an expected payload 702 based on the received PIN 614C and/or the request ID 622C. Additionally or alternatively, the server device 602 may generate the expected payload 702. In implementations where the server device 602 constructs the expected payload 702, the server device 602 may transmit only the expected payload 702 and may not transmit the PIN 614C or the request ID 622C. In certain implementations, the expected payload 702 may be constructed by modulating, encoding, and/or encrypting the PIN 614C and other associated data (e.g., the request ID 622C, the device ID 6/28 a) degenerate and expected payload 702 for an audio transmission received from the user device 606 that contains the PIN 614B (e.g., the audio transmission 740).

Upon entering the audio environment 646, the user device 606 may detect or receive an audio transmission 734 transmitted by the computing device 604 (e.g., transmitted at regular intervals) that contains the beacon 644. In response, the user device 606 may transmit an audio transmission 736 that contains the request ID 622B and the device ID 628B, similar to the audio transmission 636 above. The audio transmission 736 may be generated to indicate to the computing device 604 which request corresponds to the user device 606 and to perform initial authentication (e.g., based on the device ID 628 be). Upon receiving the audio transmission 736, the computing device 604 may compare the received request ID 622B in the device ID 628B to local copies of the device ID 628C in the request ID 622C upon determining that the device ID 628C is associated with a valid request ID 622 C, the computing device 604 may generate and audio transmission 738 containing the PIN request 730, which may be implemented similarly to the PIN request 630.

Upon receiving the audio transmission 738 and extracting the PIN request 730, the user device 606 may prompt the user to enter a PIN (e.g., and alphanumeric PIN, a biometric PIN, and the like). The user device 606 may then generate an audio transmission 740 that contains the PIN 614B (e.g., the same PIN as the PIN 614A used to originate the request). After receiving the audio transmission 740, the computing device 604 may confirm that the received PIN 614B is correct. For example, the computing device 604 may compare the received PIN 614B to the previously received PIN 614C. If the PINs 614B, 614C match, the computing device 604 may determine that the received PIN is correct. Additionally or alternatively, the computing device 604 may compare a payload of the audio transmission 740 to an expected payload 702. If all or part of the payloads match, the computing device 604 may determine that the received PIN is correct. Implementations that rely on the expected payload 702 may be more secure, as it is not necessary for the computing device 604 to store or receive a copy of the PIN 614C, which may be a secure identifier of the user. Upon confirming that the PIN 614B is correct, the computing device 604 may generate an approval 732 (similar to the approval 632) for the request and may transmit and audio transmission 742 containing the approval 732 to the user device 606. In addition, the approval 732 may be transmitted to one or more other computing devices (e.g., computing devices necessary to fulfill the request. For example, the approval 732 may be transmitted to computing devices accessed by one or more employees responsible for fulfilling the user's request (e.g., responsible for providing the requested goods or services).

In this way, the computing device 604 may be capable of verifying request identification information (e.g., request IDs, device IDs, PINs) without relying on network communication to the server device 602. This may improve the responsiveness of user validation and request fulfillment, without compromising security.

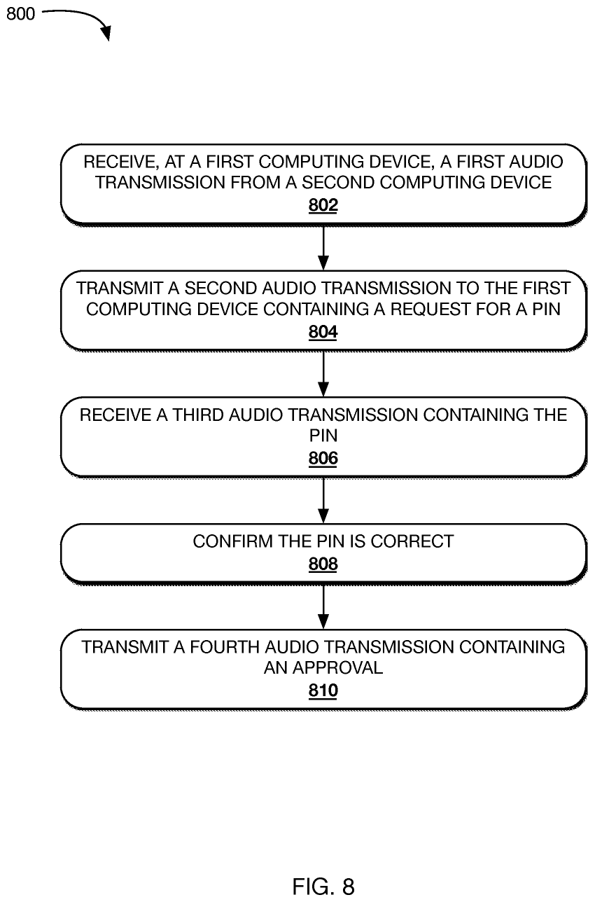

FIG. 8 illustrates a method 800 according to an exemplary embodiment of the present disclosure. The method 800 may be performed to receive and process audio transmissions to verify and securely associate a user device 606 with a previously received request ID (e.g., for a location-based service). The method 800 may be performed on a computer system, such as the system 600. For example, the method 800 may be performed by the computing device 604. The method 800 may also be implemented by a set of instructions stored on a computer readable medium that, when executed by a processor, cause the computer system to perform the method 800. For example, all or part of the method 800 may be implemented by a processor and a memory of the computing device 604. Although the examples below are described with reference to the flowchart illustrated in FIG. 8, many other methods of performing the acts associated with FIG. 8 may be used. For example, the order of some of the blocks may be changed, certain blocks may be combined with other blocks, one or more of the blocks may be repeated, and some of the blocks described may be optional.

The method 800 may begin with receiving, at a first computing device, a first audio transmission from a second computing device (block 802). For example, the computing device 604 may receive a first audio transmission 636 from a user device 606. The audio transmission may contain a request ID 622B, 622C and/or a device ID 628B. In certain implementations, the user device 606 may be configured to transmit the audio transmission 636 in response to receiving an audio transmission 634 from the computing device 604. In particular, the user device 606 may analyze received audio transmissions for an audio transmission 634 containing a beacon 644 (e.g., a predetermined audio beacon signal). Upon detecting the beacon 644 within a received audio transmission 634, the user device 606 may create and transmit the audio transmission 636.

A second audio transmission may be transmitted to the first computing device containing a request for a PIN (block 804). For example, the computing device 604 may transmit a second audio transmission 638, 738 containing a PIN request 630B, 730. In certain implementations, the second audio transmission 638 may be transmitted in response to communication with a third computing device, such as the server device 602. In particular, the computing device 604 may transmit the request ID 622C and the device ID 628B to the server device 602. In certain implementations, rather than extracting the request ID 622C and the device ID 628B separately, the computing device 604 may instead extract the payload from the audio transmission 636 and may transmit the payload to the server device 602. Communication between the computing device 604 and the server device 602 may occur via a network 608 (e.g., via one or more wired or wireless network connections). After the server device 602 validates the received request ID 622C and device ID 628B, the server device 602 may generate and transmit a PIN request 630A for a PIN associated with a user of the user device 606 to the computing device 604. The computing device 604 may receive the PIN request 630B and may generate and transmit the second audio transmission 638 to contain the PIN request 630B.

In additional or alternative implementations, the computing device 604 may itself generate the PIN request 730. For example, the computing device 604 may have previously received one or both of the device ID 628C and the request ID 622C from the server device 602. In response to receiving the first audio transmission 736, the computing device 604 may validate that the request ID 622B and the device ID 628B contained within the audio transmission 736 are valid (e.g., by comparing 2 copies of receive device IDs and request IDs from the server device 602. After identifying the corresponding device ID 628C and request ID 622C, the computing device 604 may generate the PIN request 730 and may transmit the audio transmission 738 containing the PIN request 730

A third audio transmission may be received that contains the PIN (block 806). For example, the computing device 604 may receive an audio transmission 640 from the user device 606. The audio transmission 640 may contain the PIN 614B. As explained above, the PIN 614B may be hashed, encrypted, or otherwise obfuscated in certain implementations before being added to the audio transmission 640.

It may then be confirmed whether the PIN is correct (block 808). For example, the server device 602 may confirm whether the PIN 614B received in the third audio transmission 640, 740 is correct. In one implementation, the computing device 604 may transmit the PIN 614B to the server device 602 via the network 608. For example, the computing device 604 may extract and transmit a payload of the audio transmission 640, the payload containing the PIN 614B received from the user device 606.

As another example, the computing device 604 may confirm that the PIN 614B received in the third audio transmission 740 is correct. In one implementation, the computing device 604 may compare the PIN 614B to a previously received PIN 614C from the server device 602. If the PINs 614B, 614C match, the computing device 614B may determine that the PIN 614B is correct. As another example, the computing device 604 may compare a payload of the audio transmission 740 to an expected payload 702 (e.g., generated by the computing device 604 and/or the server device 602). If the payload of the audio transmission 740 matches the expected payload 702, the computing device 604 may determine that the PIN 614B contained within the audio transmission 740 is correct.

A fourth audio transmission containing an approval may be transmitted (block 810). For example, the computing device 604 may transmit a fourth audio transmission 642, 742 containing an approval 632B, 732 to the user device 606. In certain instances, the approval 632B may be received from the server device 602. For example, the server device 602 may transmit and approval 632A after confirming that the PIN is correct. The computing device 604 may receive the approval 632A over the network 608. Additionally or alternatively the computing device 604 may generate the approval 732 after itself confirming whether the PIN is correct. The approval 632B, 732 may contain a request ID 622B that identifies the approved request. Based on the approval, the user device 606 may proceed with fulfilling the request and/or may connect to a network, such as the network 608 (e.g., the Internet) for continued communication with the server device 602, as described above.

In this manner, orders can be verified without requiring the user device to communicatively pair with the computing device 604 or the server device 602, or with any particular network within a facility. This may improve reliability and compatibility of order verification processes, as users are not required to connect their devices to particular networks or to pair their phones to particular server devices. Furthermore, the audio environment in which the computing device and the user device can communicate using audio transmissions may be limited in size. For example, the user device may need to be located within 50-300 feet of the computing device to properly exchange audio transmissions. This may ensure that user devices and corresponding orders are only verified when the user device is located near (e.g., in the same facility as) the computing device. Because the computing device may typically be located within a facility at which the user can redeem their request (e.g., for a product or location-based service), the request may only be validated once the user associated with the user device is actually present to redeem the request. This may reduce computing resources used to verify orders, as unnecessary verifications before a user arrives at the facility or other location are avoided. Furthermore, these techniques avoid the need to rely on other location determination means, such as GPS or cellular location signals. These signals can be unreliable indoors, where many requests for products and/or location-based services may be redeemed. Therefore, the method 800 improves the overall location accuracy by relying on audio transmissions and the audio environment instead. Furthermore, enabling the computing device to perform on premises validation improves the reliability and responsiveness of user authentication. Specifically, network validation may be occasionally unreliable or slow at the facility in which the computing device is locating. Enabling the computing device itself to perform user validation may reduce the time spent waiting to complete communications with the server device and may improve responsiveness for users attempt to validate.

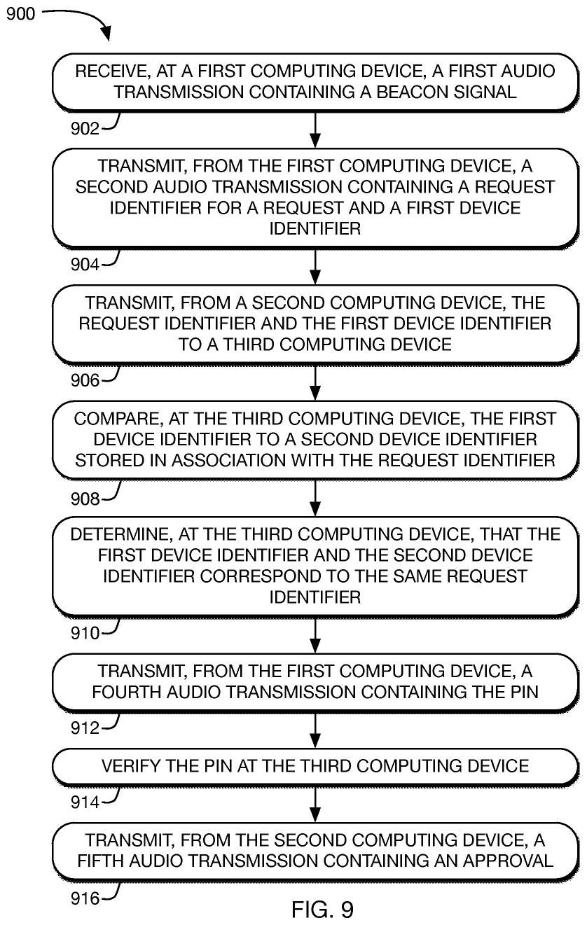

FIG. 9 illustrates a method 900 according to an exemplary embodiment of the present disclosure. The method 900 may be performed to communicate between multiple devices (e.g., a server device 602, a computing device 604, and a user device 606) to verify and securely associate a user device 606 with a previously received request ID (e.g., for a location-based service). The method 900 may be performed on a computer system, such as the system 600. For example, the method 900 may be performed by the server device 602, the computing device 604, and the user device 606. The method 900 may also be implemented by a set of instructions stored on a computer readable medium that, when executed by a processor, cause the computer system to perform the method 900. For example, all or part of the method 900 may be implemented by a processor and a memory of the server device 602, the computing device 604, and/or the user device 606. Although the examples below are described with reference to the flowchart illustrated in FIG. 8, many other methods of performing the acts associated with FIG. 8 may be used. For example, the order of some of the blocks may be changed, certain blocks may be combined with other blocks, one or more of the blocks may be repeated, and some of the blocks described may be optional.

The method 900 may begin with receiving, at a first computing device, a first audio transmission containing a beacon signal (block 902). For example, the user device 606 may receive a first audio transmission 634 that contains a beacon 644. As explained above, the audio transmission 636 may be received within an audio environment 646, which may represent the physical environment surrounding the user device 606 and the computing device 604 that transmitted the audio transmission 634. The beacon 644 may indicate that the computing device 604 is located nearby (e.g., within the audio environment 646) and is capable of communicating using audio transmissions. In certain implementations, the beacon 644 may also identify the computing device 604 and/or requests that can be verified using the computing device (e.g., may identify an associated merchant).

A second audio transmission may be transmitted from the first computing device that contains a request ID for a request and a first device ID (block 904). For example, the user device 606 may transmit an audio transmission 636 that contains a request ID 622C and a device ID 628B. As explained above, the request ID 622C may correspond to a request submitted by the user device 606 or another computing device associated with the same user (and/or associated with the same account). The device ID 628B may be generated based on a unique identifier of the user device 606 and/or based on a biometric scan of the user associated with the user device 606.

The request ID and the first device ID may be transmitted from a second computing device to a third computing device (block 906). For example, the computing device 604 may transmit the request ID 622C and the device ID 628B to the server device 602. This may be performed using techniques similar to those discussed above, such as in connection with block 804. The first device identifier may be compared, at the third computing device, to a second device identifier stored in association with the request identifier (block 908). For example, the server device 602 may compare the device ID 628B to a device ID 628A stored in association with the request ID 622A. The server device 602 may include a database 610 that stores request identifiers and device identifiers, as explained above. The server device 602 may compare the received request ID 622C to the request IDs 620, 622A stored in the database 610 and may determine that the request ID 622A is identical to the received request ID 622C. The server device 602 may then identify and compare a device ID 628A stored in association with the request ID 622A.

The third computing device may determine that the first device identifier and the second device identifier correspond to the same request identifier (block 910). For example, the server device 602 may determine that the device ID 628B and the device ID 628A correspond to the same request ID 622A, 622C. For example, the server device 602 may determine that the device ID 628A is equivalent to the device ID 628B and therefore that both devices correspond to the same request ID 622A, 622C, as the request IDs 622A, 622C were used to identify the corresponding device ID 628A in the database 610. This comparison may differ in situations where multiple device IDs are stored in association with the same request ID. For example, as explained above, a user may register multiple computing devices associated with the user or with other individuals to the user's submitted request. As a specific example, the database 610 includes two device IDs 624, 626 associated with the request ID 620. In such instances, multiple device IDs may be compared to a received device ID. For example, suppose the user 616 submitted a request with request ID 620 from their computer (associated with device ID 624) and arrives to redeem the request with their smartphone (associated with device ID 626). In such an instance, the server device 602 may receive a copy of the request ID 620 and the device ID 626. To determine whether the received device ID is correct, the server device 602 may identify both device IDs 624, 626 associated with the request ID 620 and may compare the received device ID to both device IDs 624, 626. The server device 602 may determine that the device ID 626 and the received device ID are equivalent and therefore correspond to the same request ID 620, even though the received device ID differs from the device ID 624 used to initially submit the request.

The second computing device may transmit a third audio transmission (block 912). For example, the computing device 604 may transmit an audio transmission 638. The audio transmission 638 may contain a PIN request 630B, which may be received from the server device 602. For example, in response to determining that the device IDs 628A, 628B correspond to the same request ID 622A, 622C, the server device 602 may create a PIN request 630A for a PIN 614A associated with the user 618 who submitted the request with request ID 622A. The server device 602 may transmit the PIN request 630A to the computing device 604 via the network 608, and the computing device 604 may create the audio transmission 638 containing the PIN request 630B (which may be a copy of the PIN request 630A received from the server device 602 and may transmit the audio transmission 638 to the user device via the audio environment 646.

The first computing device may transmit a fourth audio transmission containing the PIN (block 914). For example, the user device 606 may transmit an audio transmission 640 that contains a PIN 614B. The user device 606 may receive the PIN 614B from the user via one or both of a graphical user interface and a biometric scanner, as explained above. Additionally or alternatively, the PIN 614B may have been previously received from the server device 602 or another computing device (e.g., when submitting a request). Also, the PIN 614B may be hashed, encrypted, or otherwise obfuscated in the audio transmission 640 to protect the PIN from being intercepted and reused by other devices within the audio environment 646, as further explained above. The PIN 614Bs may be verified at the server device 602 (block 916). For example, the server device 602 may verify the PIN 614B received from the user device. The computing device 604 may transmit the PIN 614B (e.g., a copy of the payload of the audio transmission 640) to the server device 602. The server device 602 may compare the PIN 614B to a PIN 614A associated with a user 618 who submitted the request with request ID 622A. In certain implementations, the server device may decrypt the PIN 614B received from the user device 606 and/or may hash, encrypt, or otherwise obfuscate the PIN 614A for comparison to the PIN 614B received from the user device 606.

A fifth audio transmission may be transmitted that contains an approval (block 918). For example, the computing device 604 may transmit an audio transmission 642 that contains an approval 632B. After verifying the PIN 614B, the server device 602 may generate an approval 632A that contains a copy of the request ID 622B for the approved request. The computing device 604 may receive the approval via the network 608 and may include a copy of the approval 632B in the audio transmission 642. The computing device 604 may then transmit the audio transmission 642 to the user device 606 via the audio environment 646. Upon receiving the audio transmission 642, the user device 606 may proceed with communicating with the merchant directly via a network, as explained above. Additionally or alternatively, one or more of the devices 602, 604, 606 may display a visual indication that the user device 606 is approved to receive the product or location-based service associated with the request ID 622A.

In this manner, the method 900 enables the server device 602 and the user device 606 to communicate with one another via multiple network connections. This allows for the computing device 604 and the server device 602 to use the network 608, which may be faster, for more data intensive or secure communication, such as authorization information for requests, without also requiring the user device 606 to connect to the network 608 to exchange the data. This also improves the accuracy and security of order verification processes, as individuals (e.g., users, facility employees) are not required to receive and enter information manually to confirm when a user has arrived to redeem a request. Furthermore, the audio environment in which the computing device and the user device can communicate using audio transmissions may be limited in size. For example, the user device may need to be located within 50-300 feet of the computing device to properly exchange audio transmissions. This may ensure that user devices and corresponding orders are only verified when the user device is located near (e.g., in the same facility as) the computing device. Because the computing device may typically be located within a facility at which the user can redeem their request (e.g., for a product or location-based service), the request may only be validated once the user associated with the user device is actually present to redeem the request. This may reduce computing resources used to verify orders, as unnecessary verifications before a user arrives at the facility or other location are avoided. Furthermore, these techniques avoid the need to rely on other location determination means, such as GPS or cellular location signals. These signals can be unreliable indoors, where many requests for products and/or location-based services may be redeemed. Therefore, the method 900 also improves the overall location accuracy by relying on audio transmissions and the audio environment instead.

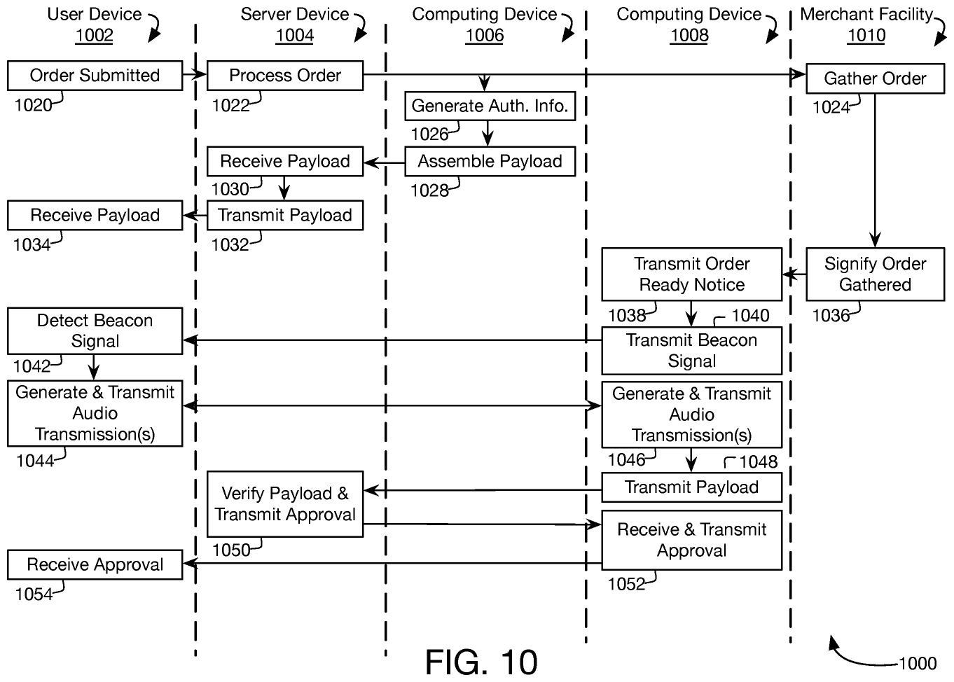

FIG. 10 illustrates a flow diagram of a method 1000 according to an exemplary embodiment of the present disclosure. The method 1000 may be an exemplary application of one or more of the techniques discussed herein. For example, the method 1000 may be performed to enable a user to submit an order for physical goods and to authenticate their physical presence at a location to pick up the physical goods. The method 1000 includes a user device 1002, a server device 1004, a computing device 1006, a computing device 1008, and a merchant facility 1010. The user device 1002 may be an exemplary implementation of the user device 606, the server device 1004 may be an exemplary implementation of the server device 602, and the computing device 1008 may be an exemplary implementation of the computing device 604. The merchant facility 1010 may be a physical location configured to store products and/or fulfill orders for those products for physical pickup and/or for shipping. For example, the merchant facility 1010 may be one or more of a store, a warehouse, a shopping center, a delivery vehicle, and the like. In certain implementations, the computing device 1008 may be located within the merchant facility 1010. The computing device 1006 may be implemented by the merchant associated with the server device 1004 and/or the merchant facility 1010. Additionally or alternatively, the computing device 1006 may be implemented by a third party (e.g., a third party providing user authentication services by audio transmission). The method 1000 may be implemented by a set of instructions stored on a computer readable medium that, when executed by a processor, cause the computer system to perform the method 1000. Although the examples below are described with reference to the flowchart illustrated in FIG. 10, many other methods of performing the acts associated with FIG. 10 may be used. For example, the order of some of the blocks may be changed, certain blocks may be combined with other blocks, one or more of the blocks may be repeated, and some of the blocks described may be optional.

The method 1000 may begin with the user device 1002 submitting an order (block 1020). For example, the user device 1002 may submit the order via an e-commerce platform and/or a website. In particular, the user device 1002 may receive a request from a user to submit the order. In response, the user device 1002 may transmit a request for the order to the server device 1004 associated with a merchant that the user ordered from. The server device 1004 may process the order (block 1022). For example, the server device 1004 may verify that the order is valid (e.g., that the requested product is in stock, that payment information is correct). The server device 1004 may also process payment for the order using payment information received from the user device 1002. Once processed, the server device 1004 may transmit information regarding the order to the merchant facility 1010. In response, the merchant facility 1010 may begin gathering the order (block 1024). For example, one or more employees, robots, and the like may begin gathering one or more products requested in the order.

Additionally, after the order is processed, the computing device 1006 may generate authentication information for the order (block 1026). For example, the computing device 1006 may receive information regarding the order from the server device 1004 (e.g., a device identifier for the user device 1002, an order identifier for the received order, an identifier of the merchant facility 1010 where the order will be fulfilled and picked up). The computing device 1006 may generate a unique identifier or PIN based on one or more of the received pieces of information, as explained further above. For example, the unique identifier may include a hash of the order identifier. The computing device 1006 may then assemble a payload for verification (block 1028). The payload may include all information required for the server device 1004 to verify a user when picking up the order. For example, the payload may include the unique identifier, all valid device identifiers associated with the user, an identifier of the merchant facility, and/or the order identifier. The server device 1004 may then transmit the payload (block 1032) to the user device 1002, which may receive the payload (block 1034). The server device 1004 may transmit all or part of the payload. For example, the server device 1004 may transmit the associated device identifiers and the unique identifier. Upon receiving the payload, the user device 1002 may extract the unique identifier for use in verifying the user device 1002 later.

The order may continue to be gathered while the authentication information and payload information is generated and exchanged. Once the order has been successfully gathered, the merchant facility 1010 may signify the order has been gathered (block 1036). For example, an employee responsible for gathering products in the order may transmit an indication that the order has been successfully gathered and is ready for user pickup. The computing device 1008, in response, may transmit an order ready notice (block 1038). For example, the computing device 1008 may generate and present a notification (e.g., a mobile phone notification, a text message notification, an email notification) to the user device 1002, so that the user is alerted that they can pick up the ordered product.

In response, the user may travel to the merchant facility 1010 and/or another location for order pickup. The computing device 1008 may be located at the order pickup location and may be configured to transmit a beacon signal (block 1040). As explained above, the beacon signal may include an audio transmission that contains a beacon indicating that the computing device 1008 is configured to transmit and receive data using audio transmissions. The user device 1002 may detect the beacon signal when the user device 1002 is located near the computing device 1008 (block 1042). In response, the user device 1002 and the computing device 1008 may generate and transmit one or more audio transmissions (blocks 1044, 1046). For example, as explained above, multiple audio transmissions may be exchanged between the user device 1002 and the computing device 1008 to transmit a request ID (e.g., the order ID for the submitted order), a device ID (e.g., a device identifier for the user device 1002), and/or a PIN (e.g., the unique identifier contained within the payload from the computing device 1006). The computing device 1008 may transmit a payload to the server device 1004 that contains the information received from the user device 1002 (block 1048). The server device 1004 may verify the received payload and transmit an approval (block 1050). For example, the server device 1004 may compare the received information to the payload received at block 1030. If the information matches, as explained further above, the server device 1004 may approve and transmit the approval to the computing device 1008. The computing device 1008 may receive and transmit the approval (block 1052). The user device 1002 may receive the approval (block 1054). In response, fulfillment of the order may proceed. For example, the user device 1002 and/or the computing device 1008 may display the approval to an employee of the merchant facility 1010, who may provide the requested goods to the user. As another example, upon receiving the approval, the computing device 1008 may unlock a secure container or locker storing the requested goods so that the user can retrieve the goods.

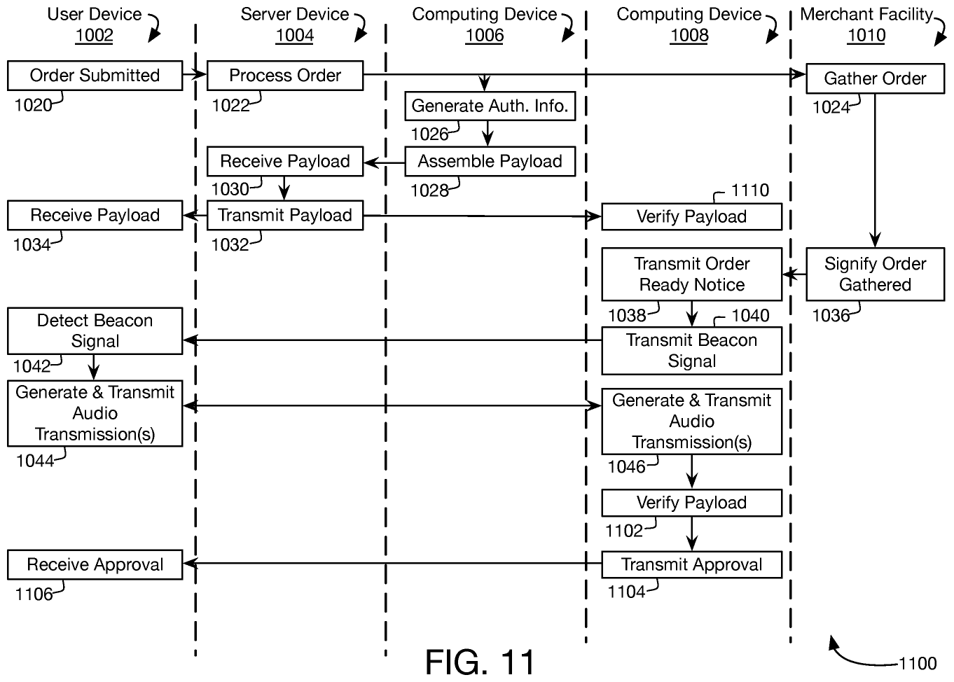

FIG. 11 illustrates a flow diagram of a method 1100 according to an exemplary embodiment of the present disclosure. The method 1100 may be an exemplary application of one or more of the techniques discussed herein. For example, the method 1100 may be performed to enable a user to submit an order for physical goods and to authenticate their physical presence at a location to pick up the physical goods. In particular, the method 1100 may be an alternative implementation of the method 1000, in which the computing device 1008 performs verification of the information received from the user device 1002. Accordingly, similar to the method 1000, the method 1100 includes a user device 1002, a server device 1004, computing devices 1006, 1008, and a merchant facility 1010, which may be implemented as discussed above. The method 1100 may be implemented by a set of instructions stored on a computer readable medium that, when executed by a processor, cause the computer system to perform the method 1100. Although the examples below are described with reference to the flowchart illustrated in FIG. 11, many other methods of performing the acts associated with FIG. 11 may be used. For example, the order of some of the blocks may be changed, certain blocks may be combined with other blocks, one or more of the blocks may be repeated, and some of the blocks described may be optional.

As the method 1100 is an alternative implementation of the method 1000, the method 1100 includes steps 1020-1046, which may be implemented as discussed above in connection with the method 1000. In block 1102, after receiving the audio transmission 740 containing the PIN 614B, the computing device 604 may verify the payload of the audio transmission 740 (block 1112). In particular, the computing device 604 may store a copy of an expected payload 702, which may be calculated by one or both of the server device 602 in the computing device 604. To verify the payload, the computing device 604 may compare the payload of the audio transmission 740 to the expected payload 702 and may verify the payload if the compared payloads match. The computing device 1008 may then transmit and approval (block 1104). In particular, in response to verifying the payload, the computing device 604 may generate an approval 732 in may transmit and audio transmission 742 that contains the approval 732. The user device 1002 may receive the approval (block 1106). In particular, the user device 606 may receive the audio transmission 742 and may extract the approval 732. In response, fulfillment of the order may proceed. For example, the user device 1002 and/or the computing device 1008 may display the approval to an employee of the merchant facility 1010, who may provide the requested goods to the user. As another example, upon receiving the approval, the computing device 1008 may unlock a secure container or locker storing the requested goods so that the user can retrieve the goods.

Thus, the techniques discussed above may be used to automatically authenticate a user at a physical location in response to detecting the user's presence. The user may not be required to manually enter any information into the user device, while still ensuring that only an authorized user is able to retrieve the requested goods.

FIG. 12 illustrates an example computer system 1200 that may be utilized to implement one or more of the devices and/or components discussed herein, such as the computing devices 102, 104, 302, 304, 402, 404, 410, 604, the 604, and/or the user device 606. In particular embodiments, one or more computer systems 1200 perform one or more steps of one or more methods described or illustrated herein. In particular embodiments, one or more computer systems 1200 provide the functionalities described or illustrated herein. In particular embodiments, software running on one or more computer systems 1200 performs one or more steps of one or more methods described or illustrated herein or provides the functionalities described or illustrated herein. Particular embodiments include one or more portions of one or more computer systems 1200. Herein, a reference to a computer system may encompass a computing device, and vice versa, where appropriate. Moreover, a reference to a computer system may encompass one or more computer systems, where appropriate.

This disclosure contemplates any suitable number of computer systems 1200. This disclosure contemplates the computer system 1200 taking any suitable physical form. As example and not by way of limitation, the computer system 1200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 1200 may include one or more computer systems 1200; be unitary or distributed; span multiple locations; span multiple machines; span multiple data centers; or reside in a cloud, which may include one or more cloud components in one or more networks. Where appropriate, one or more computer systems 1200 may perform without substantial spatial or temporal limitation one or more steps of one or more methods described or illustrated herein. As an example, and not by way of limitation, one or more computer systems 1200 may perform in real time or in batch mode one or more steps of one or more methods described or illustrated herein. One or more computer systems 1200 may perform at different times or at different locations one or more steps of one or more methods described or illustrated herein, where appropriate.

In particular embodiments, computer system 1200 includes a processor 1206, memory 1204, storage 1208, an input/output (I/O) interface 1210, and a communication interface 1212. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 1206 includes hardware for executing instructions, such as those making up a computer program. As an example, and not by way of limitation, to execute instructions, the processor 1206 may retrieve (or fetch) the instructions from an internal register, an internal cache, memory 1204, or storage 1208; decode and execute the instructions; and then write one or more results to an internal register, internal cache, memory 1204, or storage 1208. In particular embodiments, the processor 1206 may include one or more internal caches for data, instructions, or addresses. This disclosure contemplates the processor 1206 including any suitable number of any suitable internal caches, where appropriate. As an example, and not by way of limitation, the processor 1206 may include one or more instruction caches, one or more data caches, and one or more translation lookaside buffers (TLBs). Instructions in the instruction caches may be copies of instructions in memory 1204 or storage 1208, and the instruction caches may speed up retrieval of those instructions by the processor 1206. Data in the data caches may be copies of data in memory 1204 or storage 1208 that are to be operated on by computer instructions; the results of previous instructions executed by the processor 1206 that are accessible to subsequent instructions or for writing to memory 1204 or storage 1208; or any other suitable data. The data caches may speed up read or write operations by the processor 1206. The TLBs may speed up virtual-address translation for the processor 1206. In particular embodiments, processor 1206 may include one or more internal registers for data, instructions, or addresses. This disclosure contemplates the processor 1206 including any suitable number of any suitable internal registers, where appropriate. Where appropriate, the processor 1206 may include one or more arithmetic logic units (ALUs), be a multi-core processor, or include one or more processors 1206. Although this disclosure describes and illustrates a particular processor, this disclosure contemplates any suitable processor.

In particular embodiments, the memory 1204 includes main memory for storing instructions for the processor 1206 to execute or data for processor 1206 to operate on. As an example, and not by way of limitation, computer system 1200 may load instructions from storage 1208 or another source (such as another computer system 1200) to the memory 1204. The processor 1206 may then load the instructions from the memory 1204 to an internal register or internal cache. To execute the instructions, the processor 1206 may retrieve the instructions from the internal register or internal cache and decode them. During or after execution of the instructions, the processor 1206 may write one or more results (which may be intermediate or final results) to the internal register or internal cache. The processor 1206 may then write one or more of those results to the memory 1204. In particular embodiments, the processor 1206 executes only instructions in one or more internal registers or internal caches or in memory 1204 (as opposed to storage 1208 or elsewhere) and operates only on data in one or more internal registers or internal caches or in memory 1204 (as opposed to storage 1208 or elsewhere). One or more memory buses (which may each include an address bus and a data bus) may couple the processor 1206 to the memory 1204. The bus may include one or more memory buses, as described in further detail below. In particular embodiments, one or more memory management units (MMUs) reside between the processor 1206 and memory 1204 and facilitate accesses to the memory 1204 requested by the processor 1206. In particular embodiments, the memory 1204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1204 may include one or more memories 1204, where appropriate. Although this disclosure describes and illustrates particular memory implementations, this disclosure contemplates any suitable memory implementation.

In particular embodiments, the storage 1208 includes mass storage for data or instructions. As an example, and not by way of limitation, the storage 1208 may include a hard disk drive (HDD), a floppy disk drive, flash memory, an optical disc, a magneto-optical disc, magnetic tape, or a Universal Serial Bus (USB) drive or a combination of two or more of these. The storage 1208 may include removable or non-removable (or fixed) media, where appropriate. The storage 1208 may be internal or external to computer system 1200, where appropriate. In particular embodiments, the storage 1208 is non-volatile, solid-state memory. In particular embodiments, the storage 1208 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1208 taking any suitable physical form. The storage 1208 may include one or more storage control units facilitating communication between processor 1206 and storage 1208, where appropriate. Where appropriate, the storage 1208 may include one or more storages 1208. Although this disclosure describes and illustrates particular storage, this disclosure contemplates any suitable storage.

In particular embodiments, the I/O Interface 1210 includes hardware, software, or both, providing one or more interfaces for communication between computer system 1200 and one or more I/O devices. The computer system 1200 may include one or more of these I/O devices, where appropriate. One or more of these I/O devices may enable communication between a person (i.e., a user) and computer system 1200. As an example, and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 1210 may include one or more device or software drivers enabling processor 1206 to drive one or more of these I/O devices. The I/O interface 1210 may include one or more I/O interfaces 1210, where appropriate. Although this disclosure describes and illustrates a particular I/O interface, this disclosure contemplates any suitable I/O interface or combination of I/O interfaces.

In particular embodiments, communication interface 1212 includes hardware, software, or both providing one or more interfaces for communication (such as, for example, packet-based communication) between computer system 1200 and one or more other computer systems 1200 or one or more networks 1214. As an example, and not by way of limitation, communication interface 1212 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 1214 and any suitable communication interface 1212 for the network 1214. As an example, and not by way of limitation, the network 1214 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1200 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 1200 may include any suitable communication interface 1212 for any of these networks, where appropriate. Communication interface 1212 may include one or more communication interfaces 1212, where appropriate. Although this disclosure describes and illustrates a particular communication interface implementations, this disclosure contemplates any suitable communication interface implementation.

The computer system 1202 may also include a bus. The bus may include hardware, software, or both and may communicatively couple the components of the computer system 1200 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
receiving, at a first computing device, a first audio transmission from a second computing device, the first audio transmission containing a request identifier for a request and a first device identifier uniquely identifying the second computing device;
transmitting a second audio transmission containing a request for a PIN associated with a user of the second device;
receiving a third audio transmission containing the PIN;
confirming the PIN is correct; and
transmitting a fourth audio transmission containing an approval for the request.

2. The method of claim 1, wherein confirming the PIN is correct comprises comparing the PIN to an expected PIN received from a third computing device prior to receiving the first audio transmission.

3. The method of claim 1, further comprising, prior to transmitting the second audio transmission:
transmitting the request identifier and the first device identifier to a third computing device; and
receiving a request for the PIN from the third computing device.

4. The method of claim 3, wherein confirming the PIN is correct comprises:
transmitting the PIN to the third computing device; and
receiving the approval for the request from the third computing device.

5. The method of claim 3, wherein the request identifier and the first device identifier are received in a payload of the first audio transmission, and wherein the payload is defined by a merchant associated with the third computing device.

6. The method of claim 3, wherein the third computing device is a computing device associated with an online commerce platform.

7. The method of claim 3, wherein the third computing device and the first computing device are located in the same facility.

8. The method of claim 3, wherein, in response to receiving the fourth audio transmission, the second computing device and the third computing device connect and communicate using a network.

9. The method of claim 1, wherein the first device identifier is generated based on a unique identifier of the second computing device.

10. The method of claim 9, wherein the first device identifier is generated based on at least one of a location of the second computing device when the request was created, a MAC address of the second computing device, a universally unique identifier (UUID) associated with the second computing device, a clock time of the second computing device when the request was created, a pressure sensor value of the second computing device when the request was created, an ambient noise level of the second computing device when the request was created, and/or a unique value received by the second computing device upon logging into an account associated with the user.

11. The method of claim 1, wherein the first device identifier is generated based on a biometric scan of the user.

12. The method of claim 1, wherein the PIN includes at least one of (i) a unique alphanumeric identifier and (ii) a unique identifier generated based on a biometric scan of the user.

13. A system comprising:
a processor; and
a memory storing instructions which, when executed by the processor, cause the processor to:
receive, at a first computing device, a first audio transmission from a second computing device, the first audio transmission containing a request identifier for a request and a first device identifier uniquely identifying the second computing device;
transmit a second audio transmission containing a request for a PIN associated with a user of the second device;
receive a third audio transmission containing the PIN;
confirm the PIN is correct; and
transmit a fourth audio transmission containing an approval for the request.

14. A method comprising:
receiving, at a first computing device, a first audio transmission containing a beacon signal, wherein the first audio transmission was transmitted by a second computing device;
transmitting, from the first computing device, a second audio transmission containing a request identifier for a request and a first device identifier uniquely identifying the first computing device;
transmitting, from the second computing device, the request identifier and the first device identifier to a third computing device;
comparing, at the third computing device, the first device identifier to a second device identifier stored in association with the request identifier;
determining, at the third computing device, that the first device identifier and the second device identifier correspond to the request identifier;
transmitting, from the second computing device, a third audio transmission containing request for a PIN associated with a user of the first computing device;
transmitting, from the first computing device, a fourth audio transmission contain the PIN;
verifying the PIN at the third computing device; and
transmitting, from the second computing device, a fifth audio transmission containing an approval.

15. The method of claim 14, further comprising, at the first computing device:
submitting a request to an online commerce platform; and
receiving, from the online commerce platform, the request identifier.

16. The method of claim 15, wherein the third computing device is a computing device associated with the online commerce platform.

17. The method of claim 15, wherein the second device identifier was received by the third computing device before submitting the request.

18. The method of claim 15, wherein submitting the request includes submitting the first device identifier.

19. The method of claim 14, further comprising, at the first computing device:
performing a biometric scan of the user; and
generating the first device identifier based on the biometric scan.

20. The method of claim 14, wherein the first device identifier is generated based on a unique identifier of the second computing device.
